(19) United States
(12) Patent Application Publication
(10) Pub. No.: US 2025/0370111 A1
(43) Pub. Date: Dec. 4, 2025

(54) DISTANCE CALIBRATION DEVICE, DISTANCE CALIBRATION METHOD, DISTANCE CALIBRATION PROGRAM, AND DISTANCE MEASUREMENT APPARATUS

(71) Applicant: FUJIFILM Corporation, Tokyo (JP)

(72) Inventor: Yuya ISHIZUKA, Kanagawa (JP)

(73) Assignee: FUJIFILM Corporation, Tokyo (JP)

(21) Appl. No.: 19/299,367

(22) Filed: Aug. 14, 2025

Related U.S. Application Data
(63) Continuation of application No. PCT/JP2023/046629, filed on Dec. 26, 2023.

(30) Foreign Application Priority Data
Feb. 17, 2023 (JP) 2023-023521

(51) Int. Cl. G01S 7/497; G01S 17/34

(52) U.S. Cl. CPC G01S 7/497; G01S 17/34

(57) ABSTRACT

A distance calibration device and a distance calibration method are used for calibrating distances to measurement points on a surface of a measurement object, which are acquired by rotating laser light emitted from a measurement head of an FMCW LiDAR to scan the surface of the measurement object at rest. A first distance to a first measurement point among the measurement points, a second distance to a second measurement point in a vicinity of the first measurement point, and a first time point and a second time point at the first distance and the second distance are acquired. A Doppler shift is calculated based on the first distance and the second distance, the first time point and the second time point, and a wavelength of the laser light, a measurement error caused by the Doppler Shift is calculated, and the first distance is calibrated based on the calculated measurement error.

### CROSS-REFERENCE TO RELATED APPLICATIONS

The present application is a Continuation of PCT International Application No. PCT/JP2023/046629 filed on Dec. 26, 2023 claiming priority under 35 U.S.C § 119 (a) to Japanese Patent Application No. 2023-023521 filed on Feb. 17, 2023. Each of the above applications is hereby expressly incorporated by reference, in its entirety, into the present application.

### BACKGROUND OF THE INVENTION

### 1. Field of the Invention

The present invention relates to a distance calibration device, a distance calibration method, a distance calibration program, and a distance measurement apparatus, and more particularly relates to a technique for calibrating a distance to a surface of a measurement object measured using laser light.

### 2. Description of the Related Art

In a case in which the surface of the measurement object is scanned at a high speed with laser light, there is a problem in that measurement accuracy is degraded due to a Doppler shift of light.

Among the relative velocity between a measurement point on the surface of the measurement object and a measurement head that emits the laser light, a relative velocity component in the same direction as a propagation direction of the laser light (an optical axis direction of the measurement head) contributes to the Doppler shift. There are two types in which this Doppler shift occurs.
(1) Doppler shift in case in which a relationship in distance between the measurement point and the measurement head is not changed
(2) Doppler shift in case in which the relationship in distance between the measurement point and the measurement head is changed

A distance measurement apparatus that corrects an effect caused by a Doppler shift in the related art and can measure a distance with high accuracy has been proposed (JP2020-046368A).

The distance measurement apparatus disclosed in JP2020-046368A irradiates a moving measurement object (measurement object) with frequency-shifted feedback (FSF) laser light to measure a distance to the measurement object, and the occurrence of the Doppler shift corresponds to a case of (1) described above.

The Doppler shift of (1) occurs in a case in which the optical axis of the measurement head is not perpendicular to the surface of the measurement object and a component in the same direction as the optical axis direction is included in a movement direction of the measurement head or the measurement object.

The distance measurement apparatus disclosed in JP2020-046368A moves the measurement object at a plurality of speeds known in advance, obtains a beat frequency based on measurement light and reference light of FSF laser light for each speed, and obtains an angle (optical axis angle) formed between the optical axis of the measurement head and the surface of the measurement object based on a difference in speed of the measurement object, a difference in beat frequency for each speed, and a wavelength of the laser light.

In a case of measuring a distance to an actual measurement object, a speed of the measurement object with respect to the measurement head is acquired, a distance shift amount due to the Doppler shift is calculated from the wavelength of the laser light, the acquired speed of the measurement object, and the optical axis angle, the distance calculated from the beat frequency is corrected using the distance shift amount, and the distance to the measurement object is measured.

### SUMMARY OF THE INVENTION

The distance measurement apparatus disclosed in JP2020-046368A cannot calibrate an error due to the Doppler shift described in (2) described above. That is, in a case in which the measurement head is fixed and the measurement point on the surface is distance-measured by scanning the surface of the measurement object at rest with the laser light, the error due to the Doppler shift caused by the scanning with the laser light cannot be calibrated.

One embodiment according to the technology of the present disclosure provides a distance calibration device, a distance calibration method, a distance calibration program, and a distance measurement apparatus that can calibrate a distance to a surface of a measurement object, which is acquired by scanning the surface of the measurement object at rest with laser light and is affected by a Doppler shift.

A first aspect of the present invention relates to a distance calibration device comprising: a processor; and a memory that stores a program to be executed by the processor, in which the processor is configured to: acquire a first distance to a first measurement point on a surface of a measurement object and a second distance to one or more second measurement points in a vicinity of the first measurement point, which are acquired by rotating laser light emitted from a measurement head of a frequency-modulated continuous-wave (FMCW) LiDAR to scan the surface of the measurement object at rest, and two or more first and second time points, which are related to measurement time points at the first distance and the second distance, or a time point difference between the first time point and the second time point; calculate a Doppler shift based on the first distance and the second distance, the first time point and the second time point or the time point difference, and a wavelength of the laser light; and calibrate the first distance based on the Doppler shift.

According to the first aspect of the present invention, the first distance to the first measurement point on the surface of the measurement object, the second distance to one or more second measurement points in the vicinity of the first measurement point, and two or more first and second time points or the time point difference between the first time point and the second time point related to the measurement time points at the first distance and the second distance are acquired, and the first distance and the second distance, and the first time point and the second time point or the time point difference are acquired. The first distance to the first measurement point and the second distance to the second measurement point include the measurement error caused by the Doppler shift. Therefore, the Doppler shift is calculated based on the first distance and the second distance, the two or more first and second time points related to the measurement time points at the first distance and the second distance or the time point difference thereof, and the wavelength of the laser light. The first distance to the first measurement point is calibrated based on the calculated Doppler shift. As a result, it is possible to calibrate the first distance affected by the Doppler shift.

A second aspect of the present invention relates to the distance calibration device according to the first aspect, in which the processor is configured to: in a case in which the Doppler shift is denoted by f, the first distance is denoted by r1, the second distance is denoted by r2, the first time point as the measurement time point at the first distance r1 is denoted by t1, the second time point as the measurement time point at the second distance r2 is denoted by t2, and the wavelength of the laser light is denoted by λ, calculate the Doppler shift f by the following expression: f=2{(r2−r1)/(t2−t1)}/λ.

The second time point t2 may be a time point after the first time point t1 or may be a time point before the first time point t1.

A third aspect of the present invention relates to the distance calibration device according to the first aspect, in which the processor is configured to: in a case in which the Doppler shift is denoted by f, the second distances to two second measurement points before and after the first measurement point are denoted by r0 and r2, the measurement time points at the second distances r0 and r2 are denoted by t0 and t2, and the wavelength of the laser light is denoted by λ, calculate the Doppler shift f by the following expression: f=2{(r2−r0)/(t2−t0)}/λ.

As a result, it is possible to calculate the Doppler shift f at the time point t1, which is the center of the measurement time points to and t2.

A fourth aspect of the present invention relates to the distance calibration device according to the first aspect, in which the processor is configured to: in a case in which a chirp period of the laser light frequency-modulated in a triangular-wave form is denoted by 1/f_{T}, a wavelength change amount corresponding to the frequency modulation of the laser light is denoted by (λ₁−λ₂), a reference wavelength of the laser light is denoted by λ_{c}, the Doppler shift is denoted by f, and a measurement error of the first distance is denoted by Δr, calculate the measurement error Δr by the following expression: Δr=(½f_{T})×{λ_{c}²/(λ₁−λ₂)}×(f/2), to calibrate the first distance using the calculated measurement error Δr.

A fifth aspect of the present invention relates to the distance calibration device according to the first aspect, in which the processor is configured to: in a case in which a chirp period of the laser light frequency-modulated in a sawtooth-wave form is denoted by 1/f_{T}, a wavelength change amount corresponding to the frequency modulation of the laser light is denoted by (λ₁−λ₂), a reference wavelength of the laser light is denoted by λ_{c}, the Doppler shift is denoted by f, and a measurement error of the first distance is denoted by Δr, calculate the measurement error Δr by the following expression: Δr=(1/f_{T})×{λ_{c}²/(λ₁−λ₂)}×(f/2), to calibrate the first distance using the calculated measurement error Δr.

A sixth aspect of the present invention relates to a distance measurement apparatus comprising: the distance calibration device according to any one of the first to fifth aspects; the measurement head including a laser light source that emits the laser light, an interference optical system that splits the laser light into laser light for measurement and laser light for reference and causes signal light of the laser light for measurement reflected by the surface of the measurement object and reference light of the laser light for reference reflected by a reference surface to interfere with each other, and a scanning unit that rotates the signal light and scans the surface of the measurement object with the signal light; and a photodetector that detects an interference signal indicating interference light caused by the interference using the interference optical system, in which the processor is configured to: detect a beat frequency included in the interference signal based on the interference signal; calculate distances to a plurality of measurement points on a scanning line of the surface of the measurement object scanned with the laser light, based on the beat frequency; and store the calculated distances to the plurality of measurement points and measurement time points at the plurality of measurement points or a time point difference between the measurement time points at the plurality of measurement points in the memory in association with each other, and the distance calibration device calibrates the distances to the plurality of measurement points stored in the memory based on the distances to the plurality of measurement points and the measurement time points at the plurality of measurement points or the time point difference.

A seventh aspect of the present invention relates to the distance measurement apparatus according to the sixth aspect, in which the processor is configured to: in a case in which a chirp period of the laser light frequency-modulated in a triangular-wave form is denoted by 1/f_{T}, a wavelength change amount corresponding to the frequency modulation of the laser light is denoted by (λ₁−λ₂), a reference wavelength of the laser light is denoted by λ_{c}, the beat frequency is denoted by f_{BEAT}, and the distance to the measurement point is denoted by r, calculate the distance r to the measurement point by the following expression: r=(½f_{T})×{λ_{c}²(λ₁−λ₂)}×(f_{BEAT}/2).

An eighth aspect of the present invention relates to the distance measurement apparatus according to the sixth aspect, in which the processor is configured to: in a case in which a chirp period of the laser light frequency-modulated in a sawtooth-wave form is denoted by 1/f_{T}, a wavelength change amount corresponding to the frequency modulation of the laser light is denoted by (λ₁−λ₂), a reference wavelength of the laser light is denoted by λ_{c}, the beat frequency is denoted by f_{BEAT}, and the distance to the measurement point is denoted by r, calculate the distance r to the measurement point by the following expression: r=(1/f_{T})×{λ_{c}²/(λ₁−λ₂)}×(f_{BEAT}/2).

A ninth aspect of the present invention relates to the distance measurement apparatus according to the sixth aspect, in which it is preferable that the laser light source performs scanning with the laser light in a main scanning direction and a sub-scanning direction to perform two-dimensional scanning of the surface of the measurement object.

A tenth aspect of the present invention relates to a distance calibration method for calibrating distances to a plurality of measurement points on a surface of a measurement object, which are acquired by rotating laser light emitted from a measurement head of a frequency-modulated continuous-wave (FMCW) LiDAR to scan the surface of the measurement object at rest, the distance calibration method executed by a processor, the distance calibration method comprising: a step of acquiring a first distance to a first measurement point among the plurality of measurement points and a second distance to one or more second measurement points in a vicinity of the first measurement point, and two or more first and second time points, which are related to measurement time points at the first distance and the second distance, or a time point difference between the first time point and the second time point; a step of calculating a Doppler shift based on the first distance and the second distance, the first time point and the second time point or the time point difference, and a wavelength of the laser light; and a step of calibrating the first distance based on the Doppler shift.

An eleventh aspect of the present invention relates to a distance calibration program for calibrating distances to a plurality of measurement points on a surface of a measurement object, which are acquired by rotating laser light emitted from a measurement head of a frequency-modulated continuous-wave (FMCW) LiDAR to scan the surface of the measurement object at rest, the distance calibration program causing a computer to execute: a function of acquiring a first distance to a first measurement point among the plurality of measurement points and a second distance to one or more second measurement points in a vicinity of the first measurement point, and two or more first and second time points, which are related to measurement time points at the first distance and the second distance, or a time point difference between the first time point and the second time point; a function of calculating a Doppler shift based on the first distance and the second distance, the first time point and the second time point or the time point difference, and a wavelength of the laser light; and a function of calibrating the first distance based on the Doppler shift.

According to the present invention, it is possible to calibrate the distance to the surface of the measurement object, which is acquired by scanning the surface of the measurement object at rest with the laser light and is affected by the Doppler shift, and thus it is possible to acquire a highly accurate distance.

### BRIEF DESCRIPTION OF THE DRAWINGS

FIG. 1 is a conceptual diagram of distance measurement in a case in which distances to a plurality of measurement points on a surface of a measurement object are measured by emitting rotating laser light from a measurement head toward the surface of the measurement object.

FIG. 2 is a schematic diagram of an inspection system of a structure, which includes a distance calibration device according to an embodiment of the present invention.

FIG. 3 is an external view including an FMCW LiDAR.

FIG. 4 is a diagram showing main parts of an embodiment of the FMCW LiDAR.

FIG. 5 is a graph showing a triangular-wave chirp waveform of FSF laser light.

FIG. 6 is a block diagram showing an embodiment of a hardware configuration of the distance calibration device according to the embodiment of the present invention.

FIG. 7 is a flowchart showing an embodiment of a distance calibration method according to the embodiment of the present invention.

### DESCRIPTION OF THE PREFERRED EMBODIMENTS

Hereinafter, preferred embodiments of a distance calibration device, a distance calibration method, a distance calibration program, and a distance measurement apparatus according to embodiments of the present invention will be described with reference to the accompanying drawings.

### [Outline of Present Invention]

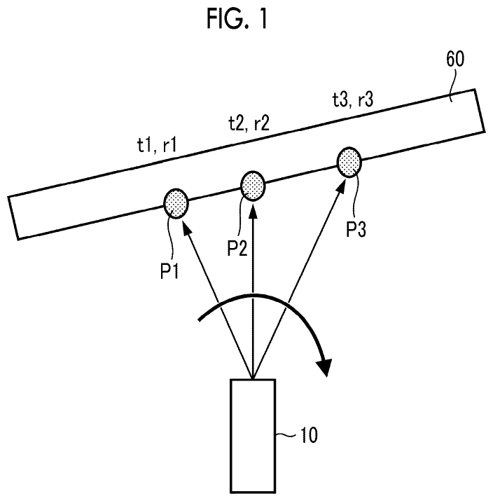

FIG. 1 is a conceptual diagram of distance measurement in a case in which distances to a plurality of measurement points on a surface of a measurement object are measured by emitting rotating laser light from a measurement head toward the surface of the measurement object.

In FIG. 1, a measurement head 10 is a measurement head of a frequency-modulated continuous-wave (FMCW) light detection and ranging (LiDAR), continuously transmits (emits) laser light while frequency-modulating a frequency of the laser light for a certain period, and emits, in the example shown in FIG. 1, the laser light that is rotated in a clockwise direction toward a surface of a measurement object 60.

As a result, the surface of the measurement object 60 is scanned from a left side to a right side of the surface with the laser light in FIG. 1, and the measurement points by the laser light are moved in the order of measurement points P1, P2, P3, and the like.

In this case, distances r1, r2, and r3 between the measurement head 10 and the measurement points P1, P2, and P3 gradually increase (r1<r2<r3), and the measurement points P1, P2, and P3 moves away from the measurement head 10, so that a Doppler shift occurs.

A shift amount thereof is determined by a speed at which the measurement point moves away (or a speed at which the measurement point moves closer) and a wavelength of the laser light, but the speed at which the measurement point moves away can be estimated from distance information measured by the LiDAR.

In FIG. 1, in a case in which the distances to the measurement points P1, P2, and P3 are measured at certain time points t1, t2, and t3 and the distances r1, r2, and r3 are obtained, the distances r1, r2, and r3 are affected by the Doppler shift.

First, the Doppler shift is calculated.

In a case in which the Doppler shift (shift frequency) is denoted by f, a speed at which a measurement point moves away (or a speed at which the measurement point moves closer) is denoted by V, and the wavelength of the laser light is denoted by λ, the Doppler shift f can be represented by the following expression.

$$f = 2 V / λ \qquad [ Math . 1 ]$$

In addition, the speed V at which the measurement point moves away can be estimated from the distances r1 and r2 to the measurement points P1 and P2 and the time points t1 and t2 that are the measurement time points of the measurement points P1 and P2 (distances r1 and r2) in accordance with the following expression.

$$V = ( r 2 - r 1 ) / ( t 2 - t 1 ) \qquad [ Math . 2 ]$$

In a case in which expression of [Math. 2] is substituted into the expression of [Math. 1], the expression of [Math. 1] can be represented by the following expression.

$$f = 2 \{ ( r 2 - r 1 ) / ( t 2 - t 1 ) \} / λ \qquad [ Math . 3 ]$$

In a case in which the wavelength λ of the laser light is measured in advance by a spectroscope or the like, the Doppler shift f can be calculated from the expression of [Math. 3].

In the present example, the time point t2 is a time point later than the time point t1, but may be a time point earlier than the time point t1. In a case in which the time point t2 is a time point later than the time point t1, the Doppler shift f is calculated based on a difference in the distance and the time point with the measurement point P2 before the measurement point P1 (in a scanning direction of the laser light), and in a case in which the time point t2 is a time point earlier than the time point t1, the Doppler shift f is calculated based on the difference in the distance and the time point with the measurement point P2 after the measurement point P1.

In addition, the Doppler shift f calculated based on the difference in the distance and the time point with the measurement point P2 before the measurement point P1 and the Doppler shift f calculated based on the difference in the distance and the time point with the measurement point P2 after the measurement point P1 may be averaged, and the average value may be used as the Doppler shift f at the measurement point P1.

Further, in a case of obtaining the Doppler shift f of the measurement point P1 (distance r1), the distances r0 and r2 of the measurement points P0 and P2 before and after the measurement point P1 and the time points to and t2 which are the measurement points of the measurement points P0 and P2 may be used without using the distance r1 and the time point t1 which is the measurement time point thereof, and the Doppler shift f may be calculated by the following expression.

$$f = 2 \{ ( r 2 - r 0 ) / ( t 2 - t 0 ) \} / λ \qquad [ Math . 4 ]$$

By calibrating the distance (r1) measured by the LiDAR based on the Doppler shift f obtained in this way, the effect (measurement error) caused by the Doppler shift can be removed.

It should be noted that, as the FMCW LiDAR, LIDAR using a frequency-shifted feedback laser (FSF laser) which is a type of the FMCW LiDAR may be used.

### [Schematic Configuration of Inspection System]

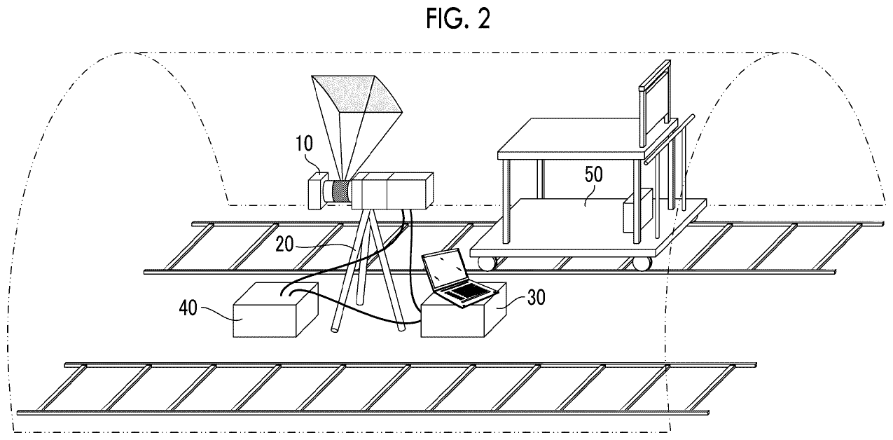

FIG. 2 is a schematic diagram of an inspection system of a structure, which includes the distance calibration device according to the embodiment of the present invention.

The inspection system shown in FIG. 2 is a system for inspecting a tunnel of a railway, and comprises the measurement head 10 of the FMCW LiDAR, a data processing device 30, and a power supply device 40.

The measurement head 10 is installed on a tripod 20, but may be installed on a cart 50 that travels on a track.

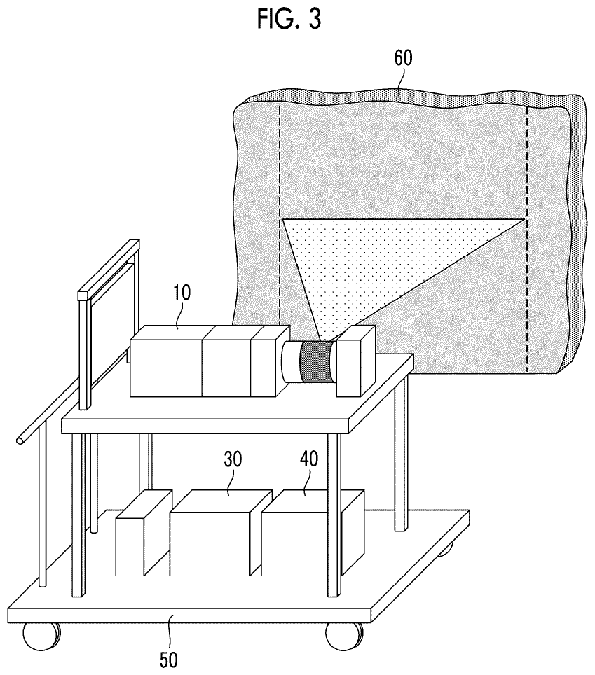

FIG. 3 is an external view including the FMCW LiDAR.

In FIG. 3, the measurement head 10 of the FMCW LiDAR is installed on the cart 50 that travels on the track as shown in FIG. 2. In addition, the data processing device 30 and the power supply device 40 are installed on the cart 50 in addition to the measurement head 10. The power supply device 40 supplies power to the measurement head 10 and the data processing device 30.

The FMCW LiDAR including the measurement head 10 measures a distance to a surface of a tunnel (measurement object 60) which is the structure of the railway.

In the example shown in FIG. 3, the measurement head 10 scans the surface of the measurement object 60 in a left-right direction (main scanning direction) of the surface of the measurement object 60 shown in FIG. 3 at a high speed with FMCW laser light, and moves a scanning line in an up-down direction (sub-scanning direction) of the surface of the measurement object 60 to perform two-dimensional scanning of the surface of the measurement object 60.

The data processing device 30 detects a frequency (beat frequency) of a beat signal output from the measurement head 10 by frequency analysis, to measure a distance to a measurement point on each scanning line of the laser light based on the detected beat frequency. It should be noted that the principle of the distance measurement using the FMCW LiDAR will be described later.

Then, the data processing device 30 measures distances to a large number of measurement points on each scanning line of the laser light emitted from the measurement head 10 (that is, on the surface of the measurement object 60), to acquire three-dimensional measurement data of a polar coordinate system consisting of an irradiation direction of the laser light and a measured distance (three-dimensional measurement data of a polar coordinate system indicating a shape of the surface of the measurement object 60). The data processing device 30 acquires three-dimensional measurement data indicating the shape of the surface of the measurement object 60 by converting the three-dimensional measurement data of the polar coordinate system into three-dimensional data of a cartesian coordinate system.

Further, by calculating the distance (height from a reference surface) in a normal direction of the three-dimensional measurement data with respect to a reference surface defined in advance on the surface of the measurement object 60, an amount of rise (amount of delamination) on the surface of the measurement object 60 can be detected.

As the three-dimensional measurement data measured by the FMCW LiDAR of the present example, the three-dimensional measurement data (point cloud data) of a large number of measurement points on the surface of the measurement object 60 is acquired as described above, but it is considered to perform the measurement under the following conditions in order to measure the minute uneven shape of the surface.
Measurement accuracy: 50 μm
Measurement distance: 2 m to 7 m
Measurement speed: 10 m²/sec in terms of area (speed of laser light is equivalent to 4000 rpm)

In a case of the FMCW LiDAR, the above-described measurement accuracy and the like can be realized, but in a case in which the scanning speed of the laser light is increased, the Doppler shift f is increased as is clear from the expression of [Math. 3], which affects the measurement accuracy.

The distance calibration device according to the present invention sequentially calculates the Doppler shift and calibrates the distances to a large number of measurement points on the surface (in the present example, a wall surface of the tunnel) of the measurement object 60 measured by the FMCW LiDAR based on the calculated Doppler shift, to remove the effect (measurement error) caused by the Doppler shift.

### [FMCW LiDAR]

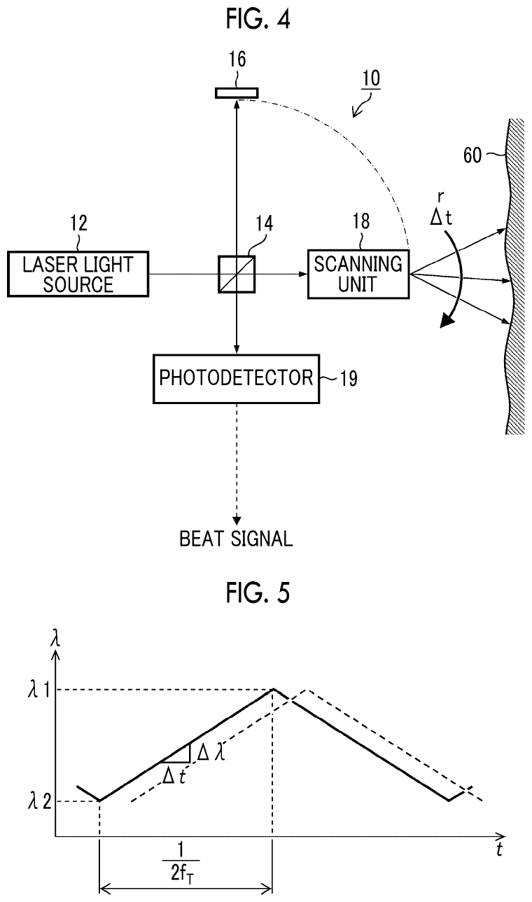

FIG. 4 is a diagram showing main parts of the embodiment of the FMCW LiDAR, and particularly shows the measurement head.

The measurement head 10 shown in FIG. 4 includes a laser light source 12, an interference optical system including a beam splitter 14 and a reference mirror 16, a scanning unit 18, and a photodetector 19.

The laser light source 12 may be, for example, the FSF laser light that oscillates by inserting an acousto-optic modulator (AOM), which is a frequency-shifting element, into the resonator and feeding back the first-order diffracted light whose frequency has been shifted by the AOM

The FSF laser light emitted from the laser light source is split into the laser light for measurement and laser light for reference by the beam splitter 14, and the laser light for reference is reflected by the reference mirror 16 and is incident on the beam splitter 14 again.

Meanwhile, the laser light for measurement is incident on the scanning unit 18. The scanning unit 18 is composed of, for example, a polygon mirror and a motor that rotates the polygon mirror, and the laser light for measurement is incident on the polygon mirror. The scanning unit 18 rotates the polygon mirror in a direction around a first axis by a motor to rotate the laser light for measurement reflected by the polygon mirror. As a result, the main scanning of the surface of the measurement object 60 is performed with the laser light for measurement. It should be noted that the polygon mirror is inclined in a direction around a second axis orthogonal to the first axis at the same time as the rotation in the direction around the first axis. As a result, the sub-scanning of the surface of the measurement object 60 is performed with the laser light for measurement. Further, a rotation speed of the polygon mirror in the direction of the first axis can be, for example, 4000 rpm.

The laser light for measurement (signal light) reflected by the surface of the measurement object 60 is incident on the beam splitter again through the scanning unit 18. The signal light incident on the beam splitter 14 and reference light reflected by the reference mirror 16 (reference surface) and incident on the beam splitter 14 are combined by the beam splitter 14 and output as interference light.

The photodetector 19 performs photoelectric conversion on the interference light output from the beam splitter 14, to detect an interference signal indicating the interference light. The interference signal detected by the photodetector 19 is applied to the data processing device 30, and the signal processing is performed here.

FIG. 5 is a graph showing a triangular-wave chirp waveform of the FSF laser light.

In the graph shown in FIG. 5, a horizontal axis is time, and a vertical axis is the wavelength of the FSF laser light. In addition, a solid line indicates the reference light, and a broken line indicates the signal light.

In the triangular-wave chirp waveform, a chirp period indicates 1/f_{T} (chirp frequency is f_{T}), and the wavelength linearly changes between the wavelengths λ₁ and λ₂. It should be noted that, as shown in FIG. 5, an up-chirp (down-chirp) period of the triangular-wave chirp waveform is ½(½f_{T}) of the chirp period.

Now, as shown in FIG. 4, in a case in which the distance from the beam splitter 14 to the reference mirror 16 and the distance to the emission surface of the scanning unit 18 are equal to each other, the signal light is incident on the beam splitter 14 in a manner delayed by a time (Δt) during which the signal light reciprocates between the emission surface of the scanning unit 18 and the measurement point on the surface of the measurement object 60 relative to the reference light.

As a result, as shown in FIG. 5, a wavelength difference (Δλ) occurs between the reference light and the signal light, and as a result, the interference light between the reference light and the signal light output from the beam splitter 14 includes a beat having a frequency corresponding to the wavelength difference (Δλ).

That is, in a case in which the beat frequency is denoted by f_{BEAT}, the wavelength difference is denoted by Δλ, the reference wavelength of the laser light is denoted by λ_{c}, and the speed of light is denoted by c, the beat frequency f_{BEAT} can be represented by the following expression.

$${f}_{B E A T} \approx c Δλ / {λ}_{c}^{2} \qquad [ Math . 5 ]$$

On the other hand, in a case in which the wavelength difference is denoted by Δλ, a time difference is denoted by Δt, the up-chirp period is (½f_{T}), and the wavelength change amount of the chirp waveform is denoted by (λ₁−λ₂), the wavelength difference Δλ can be represented by the following expression.

$$Δ λ = 2 {f}_{T} ( {λ}_{1} - {λ}_{2} ) Δ t \qquad [ Math . 6 ]$$

In addition, in a case in which the distance of the signal light that reciprocates in the time Δt is denoted by ΔL (see FIG. 4), the time Δt can be represented by the following expression from the distance ΔL and the speed of light c.

$$Δ t = Δ L / c \qquad [ Math . 7 ]$$

In a case in which an expression obtained by substituting the expression of [Math. 7] into Δt of the expression of [Math. 6] is organized by substituting the expression into Δλ of the expression of [Math. 5], the expression of [Math. 5] can be represented by the following expression.

$${f}_{B E A T} = 2 {f}_{T} ( {λ}_{1} - {λ}_{2} ) Δ L / {λ}_{c}^{2} \qquad [ Math . 8 ]$$

In addition, since the distance ΔL is a distance of round trip of the signal light corresponding to the time Δt, in a case in which the distance from the measurement head to the measurement point is denoted by r and the distance r is used instead of ΔL in the expression of [Math. 8], the expression of [Math. 8] is rewritten with an expression for obtaining the distance r, so that the following expression is obtained.

$$r = ( 1 / 2 {f}_{T} ) \times \{ {λ}_{c}^{2} / ( {λ}_{1} - {λ}_{2} ) \} \times ( {f}_{B E A T} / 2 ) \qquad [ Math . 9 ]$$

In the expression of [Math. 9], since an unknown variable is only the beat frequency f_{BEAT}, the distance r to the measurement point can be calculated by detecting the beat frequency f_{BEAT}.

That is, the data processing device 30 detects the beat frequency f_{BEAT} by performing frequency analysis on the interference signal detected by the photodetector 19, and calculates the distance r to the measurement point by the expression of [Math. 9] based on the detected beat frequency f_{BEAT} and a preset constant (f_{T}, λ_{c}, (λ₁−λ₂)).

In addition, the data processing device 30 stores the distance r to the measurement point and the measurement time point of the measurement point (for example, a specific time point within a period used for calculating the beat frequency f_{BEAT} in the up-chirp) in a storage device in the data processing device 30. This is performed for all the measurement points obtained by performing laser scanning of the surface of the measurement object 60.

### Embodiment of Distance Calibration Device

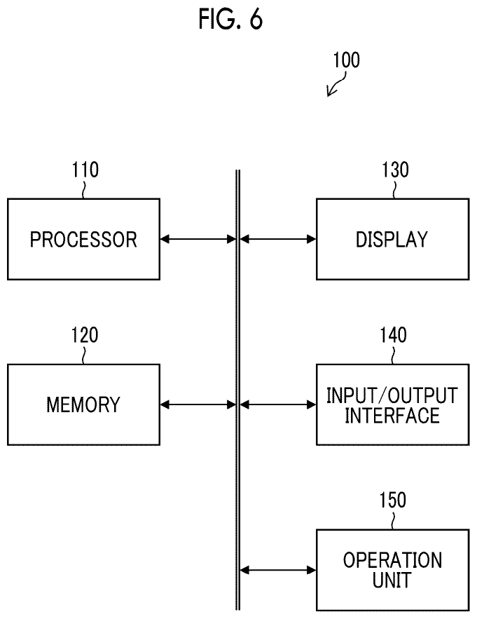

FIG. 6 is a block diagram showing an embodiment of a hardware configuration of the distance calibration device according to the embodiment of the present invention.

A distance calibration device 100 shown in FIG. 6 is, for example, configured by a personal computer, a workstation, or the like, and comprises a processor 110, a memory 120, a display 130, an input/output interface 140, and an operation unit 150. It is possible to incorporate the distance calibration device 100 as one function of the data processing device 30 shown in FIG. 2.

The processor 110 is configured by a central processing unit (CPU) or the like, and integrally controls the respective units of the distance calibration device 100 and executes a distance calibration program to perform processing of removing the effect (measurement error) caused by the Doppler shift on distances to a large number of measurement points to the surface (in the present example, the wall surface of the tunnel) of the measurement object 60 measured by the FMCW LiDAR. It should be noted that the details of various types of processing performed by the processor 110 will be described later.

The memory 120 includes a flash memory, a read-only memory (ROM), a random-access memory (RAM), a hard disk drive, and the like. The flash memory, the ROM, or the hard disk device is a non-volatile memory that stores an operating system, various programs including the distance calibration program according to the embodiment of the present invention, and the like. In addition, the distance to each measurement point on the surface of the measurement object measured by the FMCW LiDAR and a time point when each measurement point is measured are stored in a non-volatile memory (storage device) such as the flash memory and the hard disk device.

The RAM functions as a work area of processing executed by the processor 110. Various programs stored in the flash memory or the like, and a distance and a measurement time point of a plurality of measurement points on a surface of a measurement object, and at least a first distance of a first measurement point used for calculation, a second distance of one or more second measurement points in the vicinity of the first measurement point, a first time point and a second time point which are measurement points of the first distance and the second distance, and the like are temporarily stored. It should be noted that a part (RAM) of the memory 120 may be built in the processor 110.

The display 130 is also used as a part of a graphical user interface (GUI) in a case in which a user input is received from the operation unit 150, and can display an image or the like indicating a surface property (unevenness) of a measurement object created using distance information calibrated by the distance calibration device 100, in addition to displaying a screen for operating the distance calibration device 100.

The input/output interface 140 includes a connection unit connectable to an external device, a communication unit that can be connected to a network, and the like. As the connection unit connectable to the external device, a universal serial bus (USB), a high-definition multimedia interface (HDMI) (HDMI is a registered trademark), and the like can be applied.

The distance calibration device 100 can be configured as a device independent of the data processing device 30, and in this case, the processor 110 can acquire the distance to each measurement point on the surface of the measurement object and the time point of the measurement at each measurement point from the data processing device 30 via the input/output interface 140, or can acquire the distance to each measurement point on the surface of the measurement object and the time point of the measurement (measurement time point) at each measurement point from the cloud via the input/output interface 140 in a case in which the distance to each measurement point on the surface of the measurement object and the time point of the measurement at each measurement point are stored in the cloud. In addition, the processor 110 can store the distance to each measurement point on the surface of the measurement object acquired in this way and the measurement time point at each measurement point in the memory 120 in association with each other.

The operation unit 150 includes a pointing device such as a mouse, a keyboard, and the like, and uses a display screen of the display 130 to function as a part of the GUI that receives an instruction input by a user operation.

It should be noted that the display 130 and the operation unit 150 are not essential in the distance calibration device according to the embodiment of the present invention.

### <Operation of Distance Calibration Device>

An operation of the distance calibration device 100 having the above-described configuration will be described with reference to FIG. 1.

Hereinafter, a case will be described in which the distance r1 to the measurement point P1 shown in FIG. 1 is calibrated among the distances to the respective measurement points on the surface of the measurement object measured by the FMCW LiDAR.

In this case, the processor 110 acquires, from the memory 120, the distance r1 to the measurement point P1 and the distance r2 to the next measurement point P2, as well as the time points t1 and t2 of the measurement at the measurement points P1 and P2, among the distances to the respective measurement points on the surface of the measurement object and the time points of the measurement at the respective measurement points, which are stored in the memory 120.

The processor 110 calculates the Doppler shift f during the measurement at the distance r1 from the expression of [Math. 3] based on the distances r1 and r2, the time points t1 and t2, and the wavelength λ of the laser light measured in advance by the spectroscope or the like and stored in the memory 120.

It should be noted that, in the present example, in a case of calculating the Doppler shift f for the distance r1 to be calibrated, the distance r2 to the measurement point P2 next to the measurement point P1 at the distance r1 to be calibrated and the time point t2 thereof are used, but the distance r0 at the measurement point P0 measured before the measurement point P1 and the time point t0 thereof may be used, or the Doppler shift f at the time point t1 between the time point t0 and the time point t2 may be calculated by using the distances r0 and r2 at the time points t0 and t2. In short, the distance and the time point at one or more measurement points in the vicinity of the measurement point P1 other than the distance r1 of the measurement point P1 to be calibrated need only be acquired to enable the calculation of the Doppler shift, and the information (distance and measurement time point) of the plurality of measurement points used for the calculation of the Doppler shift is not limited to the present example.

In addition, in a case in which the measurement period at each measurement point that is sequentially measured is fixed, the period can be stored in the memory 120 as information on a time point difference between the time points (first time point and second time point) at which the adjacent measurement points are measured, and can be used as (t2−t1) in the expression of [Math. 3].

As described above in the expression of [Math. 9], the distance r to each measurement point is calculated based on the detected beat frequency f_{BEAT} and a preset constant, but, since the beat frequency f_{BEAT} includes the Doppler shift, the effect (measurement error) caused by the Doppler shift occurs.

Therefore, in a case in which the measurement error caused by the Doppler shift of the distance r1 at the measurement point P1 is denoted by Δr, the processor 110 substitutes the Doppler shift f instead of the beat frequency f_{BEAT} in the expression [Math. 9] and calculates the measurement error Δr by the following expression.

$$Δ r = ( 1 / 2 {f}_{T} ) \times \{ {λ}_{c}^{2} / ( {λ}_{1} - {λ}_{2} ) \} \times ( f / 2 ) \qquad [ Math . 10 ]$$

The processor 110 adds the measurement error Δr calculated from the distance r1 to the measurement point P1 based on the expression of [Math. 10] to calibrate the distance r1 affected by the Doppler shift.

The processor 110 calibrates the distances to all the measurement points in the same manner as described above, as in the calibration of the distance r1 to the measurement point P1.

It should be noted that the distance calibration device 100 does not need to be provided in the field where a large number of measurement points on the surface of the structure are measured, such as the measurement head 10 or the data processing device 30, and the measurement points can be calibrated after the measurement at the distances of the large number of measurement points on the surface of the structure is completed.

In addition, in a case in which the data processing device 30 has the function of the distance calibration device 100, the distance calibration device 100 can perform calibration by sequentially calculating the measurement error caused by the Doppler shift as long as information on at least the distance and the time point required for calculating the Doppler shift of the measurement point to be calibrated is temporarily recorded, and the data processing device 30 can store the distance after calibration in an internal memory.

### Embodiment of Distance Calibration Method

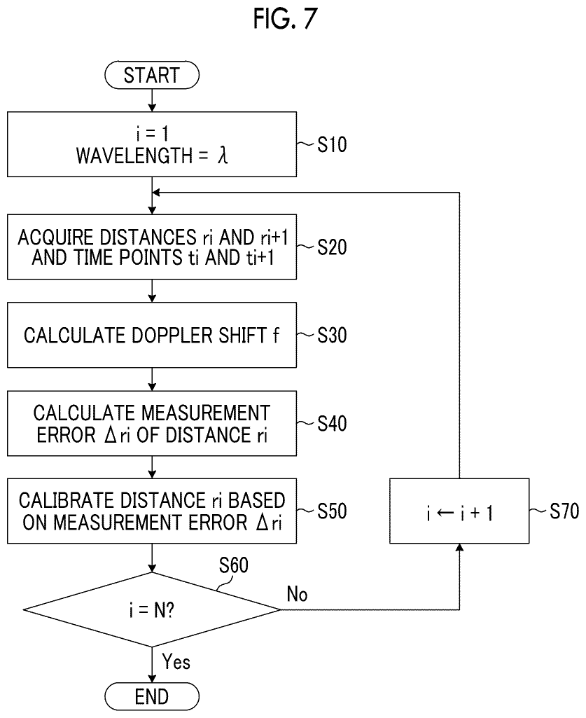

FIG. 7 is a flowchart showing an embodiment of the distance calibration method according to the embodiment of the present invention.

It should be noted that the distance calibration method shown in FIG. 7 is a method performed by the processor 110 of the distance calibration device 100 shown in FIG. 6.

In FIG. 7, the processor 110 sets the parameter i indicating the measurement point to 1, and sets the wavelength λ of the laser light (step S10). It should be noted that the wavelength λ is measured in advance by a spectroscope or the like and stored in the memory 120, and the wavelength λ stored in the memory 120 is read out and set. In the present example, it is assumed that the number of measurement points is N.

Next, the processor 110 acquires, from the memory 120, the distances ri and ri+1 corresponding to the parameter i among the distances of the measurement points on the surface of the measurement object measured by the FMCW LiDAR and the time points ti and ti+1 (step S20).

The processor 110 calculates the Doppler shift f from the expression of [Math. 3] based on the distances ri and ri+1, the time points ti and ti+1, and the wavelength λ of the laser light set in advance acquired in step S20 (step S30).

Subsequently, the processor 110 calculates the measurement error Δri of the distance ri caused by the Doppler shift f by [Math. 10] described above based on the Doppler Shift f calculated in step S30 (step S40).

The processor 110 calibrates the distance ri by subtracting the measurement error Δri calculated in step S40 from the distance ri (step S50). The processor 110 stores the calibrated distance ri in the memory 120, as the distance from which the effect of the Doppler shift f is removed (reduced).

Then, the processor 110 determines whether or not the parameter i of the measurement point has reached N (step S60).

In a case in which the processor 110 determines that the parameter i has not reached N (in a case of “No”), the processor 110 increments the parameter i by 1 (step S70) and proceeds to the processing of step S20.

On the other hand, in a case in which the processor 110 determines that the parameter i has reached N (in a case of “Yes”), the processor 110 determines that the calibration of the distances to all the measurement points has been completed, and completes the main processing.

### [Others]

In the present embodiment, a case has been described in which the laser light frequency-modulated in a triangular-wave form as shown in FIG. 5 is used as the laser light of the FMCW LiDAR, but the present invention is not limited thereto, and for example, laser light that is frequency-modulated in a sawtooth-wave form may be used. In this case, the up-chirp (down-chirp) period of the triangular-wave chirp waveform is ½(½f_{T}) of the triangular-wave chirp period, while the sawtooth-wave chirp waveform is only the up-chirp, so that the sawtooth-wave period and the chirp period match each other.

Therefore, in a case in which the distance r to the measurement point on the surface of the measurement object is calculated using the laser light that is frequency-modulated in a sawtooth-wave form, the following expression using (1/f_{T}) is used instead of (½f_{T}) in the expression of [Math. 9].

$$r = ( 1 / {f}_{T} ) \times \{ {λ}_{c}^{2} / ( {λ}_{1} - {λ}_{2} ) \} \times ( {f}_{B E A T} / 2 ) \qquad [ Math . 11 ]$$

In addition, in a case in which the measurement error Δr of the distance r to the measurement point on the surface of the measurement object is calculated using the laser light that is frequency-modulated in a sawtooth-wave form, the following expression using (1/f_{T}) is used instead of (½f_{T}) in the expression of [Math. 10].

$$Δ r = ( 1 / {f}_{T} ) \times \{ {λ}_{c}^{2} / ( {λ}_{1} - {λ}_{2} ) \} \times ( f / 2 ) \qquad [ Math . 12 ]$$

Further, the measurement object of the present embodiment is the tunnel, but the present invention is not limited thereto, and any measurement object at rest such as a bridge or a dam may be used.

In addition, in the present embodiment, for example, the hardware structure of a processing unit that executes various types of processing, such as a central processing unit (CPU), includes various processors to be described below. The various processors include a CPU that is a general-purpose processor executing the software (program) and functioning as the various processing units, a programmable logic device (PLD) that is a processor of which a circuit configuration can be changed after manufacture, such as a field programmable gate array (FPGA), and a dedicated electric circuit that is a processor of which a circuit configuration is designed for exclusive use in order to execute specific processing, such as an application specific integrated circuit (ASIC).

One processing unit may be configured by one of these various processors, or may be configured by two or more processors of same type or different types (for example, a plurality of FPGAs or a combination of the CPU and the FPGA). Moreover, a plurality of processing units may be configured by one processor. As a first example the configuration of the plurality of processing units by one processor, there is a form in which one processor is configured by combining one or more CPUs and software, and this processor functions as the plurality of processing units, as represented by a computer, such as a client or a server. Second, there is a form in which a processor, which achieves the functions of the entire system including the plurality of processing units with one integrated circuit (IC) chip, is used, as represented by a system on chip (SoC) or the like. In this manner, various processing units are configured by one or more of the various processors described above, as the hardware structure.

Further, the hardware structures of these various processors are, more specifically, an electric circuit (circuitry) in which the circuit elements, such as semiconductor elements, are combined.

Further, the present invention includes a distance measurement apparatus configured with the FMCW LiDAR including the measurement head 10 shown in FIG. 4, the photodetector 19, and the like and the distance calibration device 100. In addition, the present invention includes a distance calibration program that is installed in a computer and causes the computer to function as the distance calibration device according to the embodiment of the present invention, and a non-volatile storage medium on which the distance calibration program is recorded.

Further, the present invention is not limited to the above-described embodiments, and can be subjected to various modifications without departing from the gist of the present invention.

### EXPLANATION OF REFERENCES

10: measurement head
12: laser light source
14: beam splitter
16: reference mirror
18: scanning unit
19: photodetector
20: tripod
30: data processing device
40: power supply device
50: cart
60: measurement object
100: distance calibration device
110: processor
120: memory
130: display
140: input/output interface
150: operation unit
P1 to P3: measurement point
S10 to S70: step
f: Doppler shift
f_{BEAT}: beat frequency

What is claimed is:

1. A distance calibration device comprising:
a processor; and
a memory that stores a program to be executed by the processor,
wherein the processor is configured to:
acquire a first distance to a first measurement point on a surface of a measurement object and a second distance to one or more second measurement points in a vicinity of the first measurement point, which are acquired by rotating laser light emitted from a measurement head of a frequency-modulated continuous-wave (FMCW) LiDAR to scan the surface of the measurement object at rest, and two or more first and second time points, which are related to measurement time points at the first distance and the second distance, or a time point difference between the first time point and the second time point;
calculate a Doppler shift based on the first distance and the second distance, the first time point and the second time point or the time point difference, and a wavelength of the laser light; and
calibrate the first distance based on the Doppler shift.

2. The distance calibration device according to claim 1,
wherein the processor is configured to:
in a case in which the Doppler shift is denoted by f, the first distance is denoted by r1, the second distance is denoted by r2, the first time point as the measurement time point at the first distance r1 is denoted by t1, the second time point as the measurement time point at the second distance r2 is denoted by t2, and the wavelength of the laser light is denoted by λ, calculate the Doppler shift f by the following expression:
$$f = 2 \{ ( r2 - r 1 ) / ( t 2 - t 1 ) \} / λ .$$

3. The distance calibration device according to claim 1,
wherein the processor is configured to:
in a case in which the Doppler shift is denoted by f, the second distances to two second measurement points before and after the first distance are denoted by r0 and r2, the measurement time points at the second distances r0 and r2 are denoted by to and t2, and the wavelength of the laser light is denoted by λ, calculate the Doppler shift f by the following expression:
$$f = 2 \{ ( r 2 - r 0 ) / ( t 2 - t 0 ) \} / λ .$$

4. The distance calibration device according to claim 1,
wherein the processor is configured to:
in a case in which a chirp period of the laser light frequency-modulated in a triangular-wave form is denoted by 1/f_{T}, a wavelength change amount corresponding to the frequency modulation of the laser light is denoted by (λ₁−λ₂), a reference wavelength of the laser light is denoted by λ_{c}, the Doppler shift is denoted by f, and a measurement error of the first distance is denoted by Δr, calculate the measurement error Δr by the following expression:
$$Δ r = ( 1 / 2 {f}_{T} ) \times \{ {λ}_{c}^{2} / ( {λ}_{1} - {λ}_{2} ) \} \times ( f / 2 ) ,$$
to calibrate the first distance using the calculated measurement error Δr.

5. The distance calibration device according to claim 1,
wherein the processor is configured to:
in a case in which a chirp period of the laser light frequency-modulated in a sawtooth-wave form is denoted by 1/f_{T}, a wavelength change amount corresponding to the frequency modulation of the laser light is denoted by (λ₁−λ₂), a reference wavelength of the laser light is denoted by λ_{c}, the Doppler shift is denoted by f, and a measurement error of the first distance is denoted by Δr, calculate the measurement error Δr by the following expression:
$$Δr = ( 1 / 2 {f}_{T} ) \times \{ {λ}_{c}^{2} / ( {λ}_{1} - {λ}_{2} ) \} \times ( f / 2 ) ,$$
to calibrate the first distance using the calculated measurement error Δr.

6. A distance measurement apparatus comprising:
the distance calibration device according to claim 1;
the measurement head including a laser light source that emits the laser light, an interference optical system that splits the laser light into laser light for measurement and laser light for reference and causes signal light of the laser light for measurement reflected by the surface of the measurement object and reference light of the laser light for reference reflected by a reference surface to interfere with each other, and a scanning unit that rotates the signal light and scans the surface of the measurement object with the signal light; and
a photodetector that detects an interference signal indicating interference light caused by the interference using the interference optical system,
wherein the processor is configured to:
detect a beat frequency included in the interference signal based on the interference signal;
calculate distances to a plurality of measurement points on a scanning line of the surface of the measurement object scanned with the laser light, based on the beat frequency; and
store the calculated distances to the plurality of measurement points and measurement time points at the plurality of measurement points or a time point difference between the measurement time points at the plurality of measurement points in the memory in association with each other, and
the distance calibration device calibrates the distances to the plurality of measurement points stored in the memory based on the distances to the plurality of measurement points and the measurement time points at the plurality of measurement points or the time point difference.

7. The distance measurement apparatus according to claim 6,
wherein the processor is configured to:
in a case in which a chirp period of the laser light frequency-modulated in a triangular-wave form is denoted by 1/f_{T}, a wavelength change amount corresponding to the frequency modulation of the laser light is denoted by (λ₁−λ₂), a reference wavelength of the laser light is denoted by λ_{c}, the beat frequency is denoted by f_{BEAT}, and the distance to the measurement point is denoted by r, calculate the distance r to the measurement point by the following expression:
$$r = ( 1 / 2 {f}_{T} ) \times \{ {λ}_{c}^{2} / ( {λ}_{1} - {λ}_{2} ) \} \times ( {f}_{B E A T} / 2 ) .$$

8. The distance measurement apparatus according to claim 6,
wherein the processor is configured to:
in a case in which a chirp period of the laser light frequency-modulated in a sawtooth-wave form is denoted by 1/f_{T}, a wavelength change amount corresponding to the frequency modulation of the laser light is denoted by (λ₁−λ₂), a reference wavelength of the laser light is denoted by λ_{c}, the beat frequency is denoted by f_{BEAT}, and the distance to the measurement point is denoted by r, calculate the distance r to the measurement point by the following expression:
$$r = ( 1 / 2 {f}_{T} ) \times \{ {λ}_{c}^{2} / ( {λ}_{1} - {λ}_{2} ) \} \times ( {f}_{B E A T} / 2 ) .$$

9. The distance measurement apparatus according to claim 6,
wherein the laser light source performs scanning with the laser light in a main scanning direction and a sub-scanning direction to perform two-dimensional scanning of the surface of the measurement object.

10. A distance calibration method for calibrating distances to a plurality of measurement points on a surface of a measurement object, which are acquired by rotating laser light emitted from a measurement head of a frequency-modulated continuous-wave (FMCW) LiDAR to scan the surface of the measurement object at rest, the distance calibration method executed by a processor, the distance calibration method comprising:
a step of acquiring a first distance to a first measurement point among the plurality of measurement points and a second distance to one or more second measurement points in a vicinity of the first measurement point, and two or more first and second time points, which are related to measurement time points at the first distance and the second distance, or a time point difference between the first time point and the second time point;
a step of calculating a Doppler shift based on the first distance and the second distance, the first time point and the second time point or the time point difference, and a wavelength of the laser light; and
a step of calibrating the first distance based on the Doppler shift.

11. A non-transitory, computer-readable tangible recording medium on which a program for causing, when read by a computer, a processor of the computer to execute the distance calibration method according to claim 10 is recorded.
